(19) United States
(12) Patent Application Publication
(10) Pub. No.: US 2008/0115684 A1
(43) Pub. Date: May 22, 2008

(54) Method For Printing A Date Stamp On Package Of Food By Using Edible Ink

(75) Inventor: Eun-Jin Park, Seoul (KR)

Correspondence Address: BIRCH STEWART KOLASCH & BIRCH, PO BOX 747, FALLS CHURCH, VA, 22040-0747, US

(73) Assignee: CJ CORP., Seoul (KR)

(21) Appl. No.: 11/665,755

(22) PCT Filed: Oct. 14, 2005
(86) PCT No.: PCT/KR05/03437

§ 371 Date: Apr. 19, 2007

(30) Foreign Application Priority Data
Oct. 22, 2004 (KR) 10-2004-0084936

(51) Int. Cl. B41F 31/00

(52) U.S. Cl. 101/491

(57) ABSTRACT

Disclosed is a method of printing a date stamp on food packaging using edible ink. The method is advantageous in that, since the date stamp is printed between bottom and top films using the edible ink approved by the FDA through an inkjet process, and heat energy is applied using a seal bar to rapidly dry the ink printed on the bottom film, the date stamp is not erased by external factors during distribution, consumers are not harmed even if chemical components of the edible ink are transferred onto content of the foodstuffs, and it can be applied to a typical packaging process, thus additional cost is not required.

### TECHNICAL FIELD

The present invention relates to a method of printing a date stamp on food packaging using edible ink. More particularly, the present invention pertains to a method of printing a date stamp, in which the date stamp is printed on a bottom film using edible ink, a top film is combined therewith, and the ink is rapidly dried by heating using a seal bar so that the date stamp is prevented from being erased by the external environment, particularly, an organic solvent, and that poison, which affects humans when ink for foodstuffs is transferred onto contents eaten by humans, is removed.

### BACKGROUND ART

Generally, a method of indicating industrial markings is roughly classified into a contact-type method and a noncontact-type method. An example of the contact-type method is a sealing method in which a date stamp is printed using pressure and heat like a general stamp.

The noncontact-type method is exemplified by inkjet and laser methods. In the inkjet method, ink is sprayed to indicate a date stamp, thus the date stamp is printed on a surface of a top film or on a rear surface of a bottom film. In the laser method, a surface of a package material is burned to achieve printing.

Currently, a heat transfer method belonging to the sealing method is applied to virtually all packaged foods, including processed meat products, and, in this method, a date stamp is applied to a surface of a package material using a carbon tape.

However, the above-mentioned two methods are disadvantageous in that the date stamp is erased when exposed to an organic solvent. Particularly, it is possible to completely erase the date stamps on front and rear surfaces of a pouch using a ketone-based solvent, such as acetone, thus there is a problem in that the best-before date can be falsified.

Currently, ink for foods is used to write a date stamp on a package. However, in this case, the ink for foods is not edible ink, thus it may cause fatal diseases if humans eat it.

Meanwhile, edible ink has been recently used at home and abroad to display the best-before date on a surface of an eggshell or meat products, but there are no products on which a date stamp is printed by injecting edible ink on an internal side or a surface of a film. The reason is that since the edible ink includes water and alcohol with a high boiling point as main components, it has a very long drying time in comparison with typical ink for foods, thus it is difficult to create products using the above method in typically automatized factories.

### DISCLOSURE

### Technical Problem

In order to overcome the above-mentioned problems, the present inventor wrote a date stamp between bottom and top films using edible ink, which is approved by the FDA, through an inkjet method, and applied heat energy using a seal bar to rapidly dry ink printed on the bottom film, thereby accomplishing the present invention.

Accordingly, an object of the present invention is to provide a method of printing a date stamp on an internal surface of a package material for foods.

### Technical Solution

The above-mentioned object of the present invention is accomplished by writing a date stamp between bottom and top films using edible ink, which is approved by the FDA, through an inkjet method, and applying heat energy using a seal bar to rapidly dry ink printed on the bottom film.

Currently, a method of applying a date stamp to foods has many problems. First, the date stamp may be completely erased by an organic solvent.

This means that the best-before date can be falsified and, currently, problems resulting from falsification of the best-before date are occurring. A second problem relates to safety of contents. Typical ink for foods includes components which should not be eaten by humans. Furthermore, chemical components of the ink may be transferred onto the contents during packaging of the content.

The present invention is provided to avoid the above-mentioned problems, and relates to a method of printing a date stamp on a food package, which comprises printing the date stamp on a bottom film using edible ink, covering the resulting bottom film with a top film, and heating the resulting structure using a seal bar to dry the ink.

When using the method of printing the date stamp as described above, it is possible to avoid the above-mentioned problems without additional cost.

In the present invention, it is preferable that a temperature of the seal bar be 205-215° C. in order to rapidly dry the ink between the bottom PE film and the top film. The temperature of the seal bar is preferably within the above-mentioned range suitable to rapidly dry the ink regardless of a kind of foods to be packaged. The reason is that PE constituting an internal layer of the film may be melted when water and alcohol as main components of the ink are dried, causing attachment of the top film to the bottom film. The sealing is conducted at an edge of a pouch, thus freshness and a storing temperature of foods to be packaged are not influenced.

Accordingly, the method of printing the date stamp according to the present invention can be applied to foods which are products that use a pouch.

In detail, the products are exemplified by processed meat products, resin meat products, frozen meat products, processed marine products, fresh marine products, frozen marine products, kimchi foodstuffs, corned foodstuffs, processed legume products, and health foods.

The processed meat products are produced by processing and treating meat so that the meat is stored for a long time while it does not go bad but nutrients are preserved. They include cooked and semi-cooked products known in the art. They are exemplified by ham, sausage, bacon, and meat dried for storage.

The processed marine products are produced by processing and treating marine products so that the marine products are stored for a long time while they do not go bad but nutrients are preserved. They include cooked and semi-cooked products known in the art. They are exemplified by dried marine products, smoked marine products, salted marine products, fish jelly products (fish pastes), marine seasoning products, processed spawn products, fish meal, processed kelp meal, salted fish, fish sausage, and fish ham.

The frozen products include processed meat and marine products which are distributed in a frozen state, and may be exemplified by precooked frozen products, such as frozen dumplings, frozen noodles, frozen hamburgers, frozen breaded cutlets, frozen fried fish, frozen meatballs, frozen gratins, and frozen croquettes.

The fresh meat and marine products are packaged and distributed in a raw state without processing, and are exemplified by beef, pork, chicken meat, Tapes philippinarum, Cyclina sinensis, marsh clams, scallops, sea mussels, ark shells, clams, cockles, solens, clam meat, ear shells, and turban shells.

The kimchi foodstuffs are products in which processed kimchi is distributed while it is packaged in a pouch, and are exemplified by poggi kimchi, mat kimchi, sliced white-radish kimchi, suk-bak-chi, pickled young radishes, baek kimchi, pickled mustard leaves and stems, Korean-leek kimchi, pickled scallions, young radish kimchi, watery kimchi made of sliced radishes, watery radish kimchi, and stuffed cucumber pickles.

The corned foodstuffs are packaged in a pouch to be distributed, and are exemplified by pickled radishes, cucumbers pickled in salt, cayenne peppers seasoned with soy sauce, radish pickles, pickled garlic, garlic stalks seasoned with soy sauce, seasoned sesame leaves, beans cooked in soy sauce, seasoned scallions, gingers seasoned with vinegar, and seasoned dried radish slices.

The processed legume products are products in which foodstuffs produced by processing legumes are distributed while they are packaged in a pouch or in other packaging materials made of PE, and are exemplified by packaged bean curds, soft bean curds, uncurdled bean curds, green-pea jelly, and acorn-starch jelly.

In order to accomplish the above object, the present invention has the following characteristics.

FIG. 1 schematically illustrates a method of printing a date stamp according to the present invention, which is used to avoid a problem regarding erasing of the date stamp.

Conventionally, a date stamp is printed on front and rear sides of bottom and top films. In the present invention, the printing is applied to internal sides of the bottom and top films. In connection with this, if the date stamp is printed on the internal side of the top film, characters of the best-before date are inverted from left and right. Thus, the date stamp is written on a PE layer constituting the internal side of the bottom film.

FIG. 2 illustrates a mechanism of avoiding a problem regarding the erasing by changing the method of printing the date stamp as shown in FIG. 1. From FIG. 2, it can be seen that since a side on which the ink is printed is covered with the film, it is possible to prevent the date stamp from being exposed to an organic solvent or other undesirable factors.

FIG. 3 illustrates a reason why the edible ink is used. Contents of a conventional skin package of processed meat products may be exposed to ink for foods in a production process. However, if edible ink is used, a problem regarding harmfulness of the ink for foods is avoided and the products are processed so as to be harmless to humans if humans eat them. Any edible ink may be used, as long as it is approved by the FDA as a coloring additive added to foods and drugs. The edible ink may be exemplified by Videojet ink 16-9301 manufactured by Videojet Technologies, Inc. of the USA. However, the use of edible ink merely increases safety to humans, but does not affect prevention of erasing, which is one of the advantages of the method of printing the date stamp according to the present invention.

Meanwhile, the conventional ink for foods is rapidly dried. However, a time taken to dry the edible ink, which is approved by the FDA and used in the art, is long, because the edible ink includes water and alcohol with a high boiling point as base solvents, thus, when it is injected onto a plastic film to print the date stamp thereon, it is, undesirably, not rapidly dried. In order to avoid this problem, in the present invention, heat energy is applied using a seal bar as shown in FIG. 4 to rapidly vaporize the base solvents from the insufficiently dried edible ink and thus to prevent spreading, thereby achieving printing of the date stamp.

A better understanding of the present invention may be obtained through the following examples which are set forth to illustrate, but are not to be construed as the limit of the present invention.

### ADVANTAGEOUS EFFECTS

As described above, a method of printing a date stamp on food packaging using edible ink according to the present invention is advantageous in that, since the date stamp is printed between bottom and top films using the edible ink approved by the FDA through an inkjet process, and heat energy is applied using a seal bar to rapidly dry the ink printed on the bottom film, the date stamp is not erased by external factors during distribution, consumers are not harmed even if chemical components of the edible ink are transferred onto content of the foodstuffs, and it can be applied to a typical packaging process, thus additional cost is not required.

### DESCRIPTION OF DRAWINGS

FIG. 1 illustrates a method of printing a date stamp according to the present invention;

FIG. 2 illustrates avoidance of a problem regarding erasing, using the method of printing the date stamp according to the present invention;

FIG. 3 illustrates changing of ink for printing the date stamp from ink for foods to edible ink;

FIG. 4 illustrates a method of printing a date stamp on food packaging using edible ink according to the present invention;

FIG. 5 illustrates bacon products upon which a date stamp is printed, using the method according to the present invention, and which are completely packaged; and

FIG. 6 is an enlarged view of a date stamp printed portion of the bacon products upon which a date stamp is printed, using the method according to the present invention, and which are completely packaged.

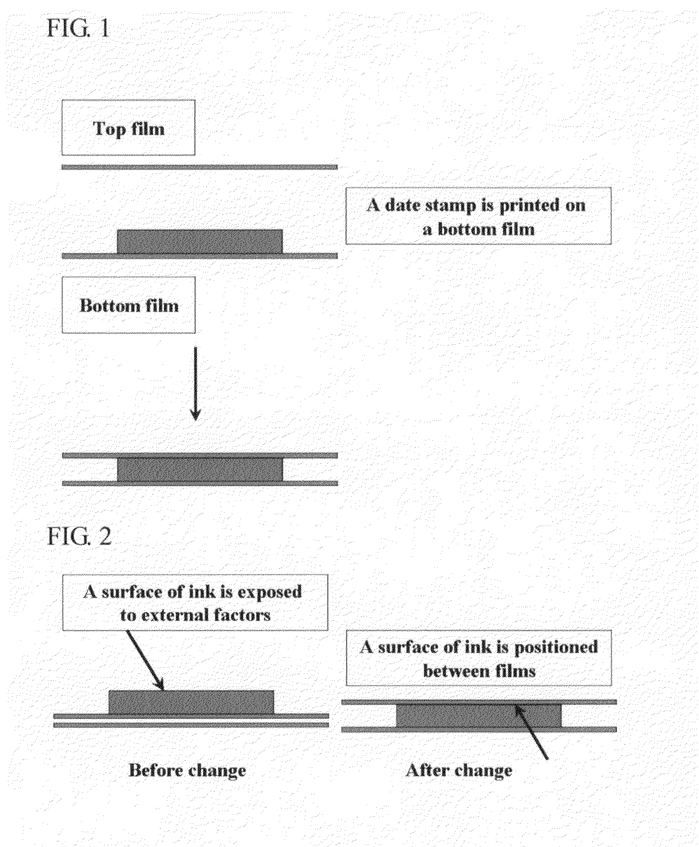

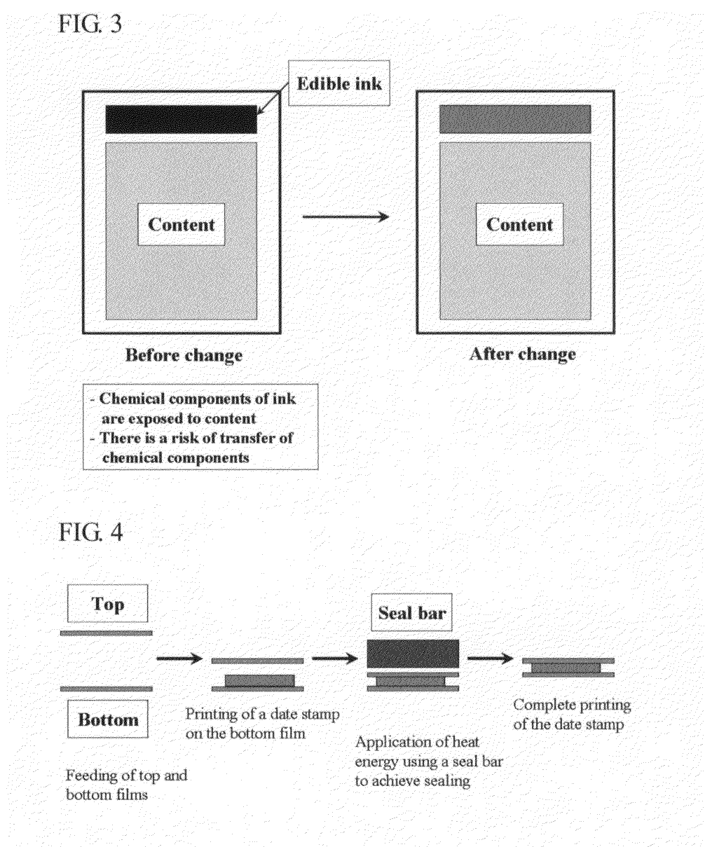

### BEST MODE

### Example 1

### Printing of Date Stamp on Processed Meat Products

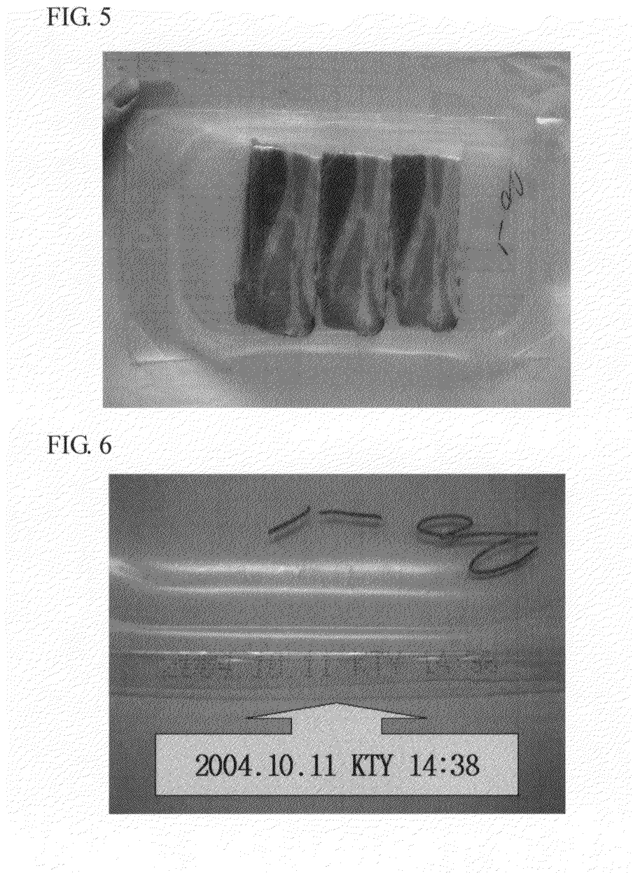

Among the processed meat products, a date stamp was printed on bacon on a PE bottom film using an inkjet method, a PE top film covered it so as to create a vacuum, and the resulting structure was pressed using a seal bar at 210° C. to achieve sealing. The resulting product is shown in FIG. 5. FIG. 6 is an enlarged view of a date stamp printed portion of FIG. 5.

### MODE FOR INVENTION

### Example 2

### Printing of Date Stamp on Frozen Foodstuffs

Among the frozen foodstuffs, a date stamp was printed on frozen meatballs, which were completely produced, on a PE bottom film using an inkjet method during a packaging process, a PE top film covered it so as to create a vacuum, and the resulting structure was pressed using a seal bar at 215° C. to achieve sealing. The completely packaged foodstuffs were frozen and stored.

### Example 3

### Printing of Date Stamp on Fresh Products

Among the fresh products, a date stamp was printed on boned ribs of pork on a PE bottom film using an inkjet method in the course of packaging the boned ribs of pork, a top film made of PE at an internal side thereof covered it, the boned ribs were put into a three-sided pouch which was produced by heating using a seal bar at 205° C., the pouch was vacuumized, and sealing was conducted.

### Example 4

### Printing of Date Stamp on Kimchi Products

Among the kimchi products, a date stamp was printed on poggi kimchi, which was completely produced, on a PE bottom film using an inkjet method during a packaging process, a top film made of PE at an internal side thereof covered it, the kimchi was put into a M-shaped pouch which was produced by heating using a seal bar at 212° C., and sealing was conducted, thereby the packaging was completed.

### Example 5

### Printing of Date Stamp on Corned Foodstuffs

Among the corned foodstuffs, a date stamp was printed on pickled radishes, which were completely produced, on a PE bottom film using an inkjet method during a packaging process, a top film made of PE at an internal side thereof covered it, the pickled radishes were put into a T-shaped pouch which was produced by heating using a seal bar at 210° C., and sealing was conducted, thereby the packaging was completed.

### Example 6

### Printing of Date Stamp on Processed Legume Products

Among the processed legume products, a date stamp was printed on uncurdled bean curds, which were completely produced, on a PE bottom film using an inkjet method during a packaging process, a top film made of PE at an internal side thereof covered it, the uncurdled bean curds were put into a three-sided pouch which was produced by heating using a seal bar at 208° C., and sealing was conducted, thereby the packaging was completed.

### INDUSTRIAL APPLICABILITY

As described above, a method of printing a date stamp on food packaging using edible ink according to the present invention is advantageous in that, since the date stamp is printed between bottom and top films using the edible ink approved by the FDA through an inkjet process, and heat energy is applied using a seal bar to rapidly dry the ink printed on the bottom film, the date stamp is not erased by external factors during distribution, consumers are not harmed even if chemical components of the edible ink are transferred onto content of the foodstuffs, and it can be applied to a typical packaging process, thus additional cost is not required. Accordingly, the present invention is very useful in the food industry.

1. A method for printing a date stamp on a package of foods using edible ink.

2. The method as set forth in claim 1, wherein the date stamp is printed on a bottom film using the edible ink, the resulting bottom film is covered with a top film, and heat is added thereto using a seal bar to dry the ink.

3. The method as set forth in claim 2, wherein a temperature of the seal bar is 205-215° C.

4. The method as set forth in claim 1, wherein the foods are selected from a group consisting of processed meat products, fresh meat products, frozen meat products, processed marine products, fresh marine products, frozen marine products, kimchi foodstuffs, corned foodstuffs, processed legume products, and health foods.

5. The method as set forth in claim 2, wherein the foods are selected from a group consisting of processed meat products, fresh meat products, frozen meat products, processed marine products, fresh marine products, frozen marine products, kimchi foodstuffs, corned foodstuffs, processed legume products, and health foods.
